(19) United States
(12) Patent Application Publication
(10) Pub. No.: US 2015/0205779 A1
(43) Pub. Date: Jul. 23, 2015

(54) SERVER FOR CORRECTING ERROR IN VOICE RECOGNITION RESULT AND ERROR CORRECTING METHOD THEREOF

(71) Applicant: SAMSUNG ELECTRONICS CO., LTD., Suwon-si (KR)

(72) Inventors: Eun-sang BAK, Ansan-si (KR); Kyung-duk KIM, Suwon-si (KR); Hyung-jong NOH, Suwon-si (KR); Geun-bae LEE, Seoul (KR); Jun-hwi CHOI, Pohang-si (KR)

(73) Assignee: SAMSUNG ELECTRONICS CO., LTD., Suwon-si (KR)

(21) Appl. No.: 14/582,638

(22) Filed: Dec. 24, 2014

(30) Foreign Application Priority Data
Jan. 17, 2014 (KR) 10-2014-0006252

(51) Int. Cl. G06F 17/27; G10L 15/01

(52) U.S. Cl. CPC G06F 17/273; G10L 15/01

(57) ABSTRACT

A server and method for correcting an error of a voice recognition result are provided. The method includes, in response to recognizing a user voice, determining a pattern of parts of speech of text data corresponding to the recognized user voice; comparing a prestored standard pattern of parts of speech with the pattern of parts of speech of text data; detecting an error region of the recognized user voice based on a result of the comparing; and correcting the text data corresponding to the detected error region.

### CROSS-REFERENCE TO RELATED APPLICATIONS

This application claims priority from Korean Patent Application No. 10-2014-0006252 filed in the Korean Intellectual Property Office on Jan. 17, 2014, the disclosure of which is incorporated herein by reference.

### BACKGROUND

1. Field

Methods and apparatuses consistent with exemplary embodiments relate to a server and a method of correcting an error of a voice recognition result thereof, and more particularly to a server capable of correcting an error of a voice recognition result using the parts of speech of the sentence corresponding to the recognized user voice, and an error correcting method of the voice recognition result.

2. Description of the Related Art

Recently, there are a growing number of electronic devices having voice recognition functions. Therefore, various modules or servers that recognize voice using various methods and output the recognized voice recognition result are being developed. However, numerous errors may occur when using a voice recognition technique due to external noise, and utterance characteristics such as user's pronunciation and speaking speed and the like. Therefore, research is being conducted for techniques of recognizing errors and also correcting the recognized errors.

However, just as there are numerous voice recognition modules or servers, there are numerous different methods of recognizing voice depending on each module or server, as well as various techniques of correcting error in the recognized voice of the user.

Therefore, there is a need for a technique whereby errors in a voice recognition result may be corrected in a uniform method, even with different voice recognition modules, server types or manufacturers.

### SUMMARY

One or more exemplary embodiments provide a and method for correcting an error of a result of voice recognition thereof that may efficiently correct an error that may exist in the result of user voice recognition uttered by the user.

According to an aspect of an exemplary embodiment, there is provided a method of correcting an error of a voice recognition result, the method including: in response to recognizing a user voice, determining a pattern of parts of speech of text data corresponding to the recognized user voice; comparing a prestored standard pattern of parts of speech with the pattern of parts of speech of text data; detecting an error region of the recognized user voice based on a result of the comparing; and correcting the text data corresponding to the detected error region.

The detecting may include determining a standard pattern of parts of speech having a highest possibility of corresponding to the pattern of parts of speech of the text data of among a plurality of prestored standard patterns of parts of speech; aligning the determined standard pattern of parts of speech with the pattern of parts of speech of the text data; comparing the aligned standard pattern of parts of speech with the pattern of parts of speech of the text data and determining a different section; and detecting the different section of among the pattern of parts of speech of the text data as being the error region.

The correcting may include determining a correct part of speech of the error region using the aligned standard pattern of parts of speech; determining a candidate word having a highest pronunciation similarity and frequency of usage of among candidate words corresponding to the correct pattern of part of speech and correcting the error region of the text data to the correct word.

In response to a portion of the pattern of parts of speech of a plurality of words configuring the text data not corresponding to the prestored standard pattern of parts of speech, the detecting may include detecting a section corresponding to the portion of the plurality of the words as being an error section.

The correcting may include determining a correct pattern of parts of speech corresponding to the portion of the pattern of parts of speech of among the plurality of words; determining a candidate word having a highest pronunciation similarity and frequency of usage of among candidate words corresponding to the correct pattern of part of speech; and correcting the error region of the text data to the correct word.

In response to the possibility of usage of some word combination of among a plurality of words configuring the text data being less than a predetermined value, the detecting may include detecting the some word combination as being an error region.

The correcting may include determining a pattern of parts of speech of the error region; and determining a candidate word having the highest pronunciation similarity and frequency of usage of among candidate words corresponding to pattern of part of speech of the error region and correcting the error region of the text data to the correct word.

The detecting may include calculating a possibility of a first word and a second word of among a plurality of words configuring the text data being included in a same sentence; and in response to the possibility of the first word and second word being included in a same sentence being less than a predetermined value, detecting at least one of the first word and second word as being an error region.

The detecting may include comparing the prestored standard pattern of parts of speech with the pattern of parts of speech of the text data based on n-gram, and detecting an error region of the recognized user voice.

According to an aspect of another exemplary embodiment, there is provided a server for error correction of a voice recognition result, the server including: a determiner configured to, in response to a user voice being recognized, determine a pattern of parts of speech of obtained text data corresponding to the recognized user voice; a storage configured to store a standard pattern of parts of speech; a detector configured to compare the standard pattern of parts of speech stored in the storage with the pattern of parts of speech of the text data determined by the determiner and detect an error region of the recognized user voice based on a result of the comparison; and a corrector configured to correct text data corresponding to the error region detected by the detector.

The detector may be configured to determine a standard pattern of parts of speech having a highest possibility of corresponding to the pattern of parts of speech of the text data of among the plurality of standard patterns of parts of speech stored in the storage, align the determined standard pattern of parts of speech with the pattern of parts of speech of the text data, compare the aligned standard pattern of parts of speech and the pattern of parts of speech of the text data to determine a different section, and detect the different section of among the pattern of parts of speech of the text data as being the error region.

The corrector may be configured to determine a correct part of speech of the error region using the aligned standard pattern of parts of speech and determine a candidate word having a highest pronunciation similarity and frequency of usage of among candidate words corresponding to the correct pattern of part of speech and correct the error region of the text data to the correct word.

The detector may be configured to, in response to a portion of the pattern of parts of speech of a plurality of words configuring the text data not corresponding to the prestored standard pattern of parts of speech, detect a section corresponding to the portion of the plurality of the words as being an error section.

The corrector may be configured to determine a correct pattern of parts of speech corresponding to the portion of the pattern of parts of speech of among the plurality of words and determine a candidate word having a highest pronunciation similarity and frequency of usage of among candidate words corresponding to the correct pattern of part of speech and correct the error region of the text data to the correct word.

In response to the possibility of usage of a word combination of among a plurality of words configuring the text data being less than a predetermined value, the detecting may be configured to detect the word combination as being an error region.

The corrector may be configured to determine a pattern of parts of speech of the error region, determine a candidate word having a highest pronunciation similarity and frequency of usage of among candidate words corresponding to pattern of part of speech of the error region and correct the error region of the text data to the correct word.

The detector may be configured to calculate a possibility of a first word and the second word of among a plurality of words configuring the text data being included in a same sentence; and in response to the possibility of the first word and second word being included in a same sentence being less than a predetermined value, detect at least one of the first word and second word as being an error region.

The detector may be configured to compare the prestored standard pattern of parts of speech with the pattern of parts of speech of the text data based on n-gram, and detect an error region of the recognized user voice.

### BRIEF DESCRIPTION OF THE DRAWINGS

The above and/or other aspects will be more apparent by describing certain exemplary embodiments with reference to the accompanying drawings, in which:

FIG. 1 is a block diagram of a configuration of a server for correcting an error of a voice recognition result, according to an exemplary embodiment;

FIG. 2 illustrates a method for aligning a pattern of the parts of speech of text data and a standard pattern of parts of speech prestored in a storage, and detecting an error region according to an exemplary embodiment;

FIG. 3 illustrates a configuration of a detector according to an exemplary embodiment;

FIG. 4 is illustrates a configuration of a storage and corrector according to an exemplary embodiment;

FIG. 5 illustrates a method for detecting an error region by calculating the possibility a combination of words can be included in a same sentence; and

FIGS. 6 and 7 are flowcharts illustrating a method for correcting an error of a voice recognition result.

### DETAILED DESCRIPTION

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

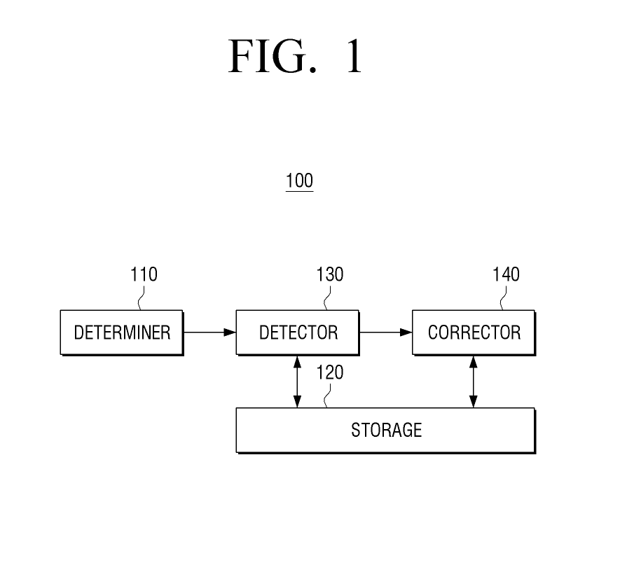

FIG. 1 is a block diagram schematically illustrating a configuration of a server according to an exemplary embodiment. As illustrated in FIG. 1, a server 100 includes a text data obtainer (not illustrated), determiner 110, storage 120, detector 130, and corrector 140. FIG. 1 illustrates each of the configurative elements in the case that the server 100 is a device having various functions including the voice recognition function, a function of correcting a voice recognition result, a storage function, a function of determining parts of speech, and a function of outputting corrected data. Therefore, depending on exemplary embodiments, one or more of the configurative elements illustrated in FIG. 1 may be omitted, changed or combined, or other configurative elements may be added thereto. Further, one or more elements may be implemented via hardware processor, a computer or a circuit.

The text data obtainer is configured to obtain text data that corresponds to a recognized user voice, in response to the user voice being obtained. That is, the server 100 may receive a user voice uttered, analyze the received user voice via natural language processing and the like, and obtain text data corresponding to the analyzed user voice via the data obtainer. The text data obtainer may receive text data corresponding to the user voice recognized in a separate voice recognition server and obtain the text data.

The determiner 110 is configured to determine a pattern of parts of speech of text data obtained in various methods via the text data obtainer. A pattern of parts of speech refers to at least one part of speech that is connected and obtained by tagging a part of speech to each word included in the text data in a promised analysis cover format. The promised analysis cover format refers to a promised symbol indicating NN for noun, NP for pronoun, and VV for verb.

The storage 120 is configured to store a standard pattern of parts of speech. That is, the server 100 may analyze parts of speech of all languages of a user that can be recognized by the voice recognition function, and tag a part of speech cover according to each part of speech, thereby creating a pattern of parts of speech. In addition, the storage 120 may store various patterns of parts of speech determined in the determiner 110 as a standard pattern of parts of speech.

The detector 130 is configured to compare the standard pattern of parts of speech stored in the storage 120 with the pattern of parts of speech of the text data determined via the determiner 110, and detecting an error region of the recognized user voice.

That is, the detector 130 may determine which pattern of parts of speech has the highest possibility of corresponding to the pattern of parts of speech of the text data, of among a plurality of patterns of parts of speech stored in the storage 120. For example, the detector 130 may determine which pattern of parts of speech has the highest possibility of corresponding to the pattern of parts of speech of the text data by comparing the order in which the parts of speech of the text data are arranged with those in the plurality of patterns of parts of speech.

In addition, the detector 130 may align the determined pattern of the standard parts of speech with the pattern of the parts of speech of the text data, compare the determined aligned pattern of parts of speech with the pattern of parts of speech of the text data, and determine which section is different. In addition, the detector 130 may detect the different section of among the pattern of parts of speech of the text data as an error region.

The corrector 140 is a configurative element for correcting the text data corresponding to the error region detected by the detector 130. That is, the corrector 140 may determine the correct parts of speech of the error region using the aligned pattern of parts of speech. For example, regarding the region of which standard pattern of parts of speech is different from the pattern of parts of speech of the text data, the corrector 140 may determine the standard pattern of parts of speech as the correct parts of speech of the text data.

In addition, the corrector 140 may determine a candidate word having a highest similarity in pronunciation and frequency of usage of among candidate words corresponding to the correct parts of speech as being the correct word, and correct the error region of the text data corresponding to the correct word.

Furthermore, when a portion of the pattern of parts of speech configuring the text data does not correspond to the standard pattern of parts of speech stored in the storage 120, the detector 130 may detect the section corresponding to the portion of the plurality of words as being an error region. Herein, the corrector 140 may determine a correct pattern of parts of speech corresponding to the portion of the pattern of parts of speech of among the plurality of words, determine a candidate word having the highest pronunciation similarity and frequency of usage of among the candidate words corresponding to the correct pattern of parts of speech as the correct word, and correct the error region of the text data to the correction word.

For example, parts of speech such as “adjective+verb” that is not appropriate to be sequentially listed is not stored in the standard pattern of parts of speech. Therefore, in response to a portion of the text data being determined as being a pattern of parts of speech of “adjective+verb” by the determiner 110, the detector 130 may detect the region determined as being a pattern of parts of speech of “adjective+verb” as being an error region.

In addition, the corrector 140 may determine the part of speech that goes well with “adjective” (for example, noun) and determine “adjective+noun” as the correct pattern of parts of speech or determine the part of speech that goes well with “verb” (for example, adverb) and determine “adverb+verb” as the correct pattern of parts of speech. The corrector 140 may also determine a candidate word having the highest pronunciation similarity and frequency of usage of among candidate words corresponding to the “adverb+verb” pattern and correct the error region of the text area to the correct word.

Furthermore, in response to the usage possibility of one or more word combinations of the plurality of words configuring the text data being less than a predetermined value, the detector 130 may detect the one or more word combinations as being an error region. Herein, the corrector 140 may determine the pattern of parts of speech of the error region, determine the candidate word having the highest pronunciation similarity and frequency of usage of among the candidate words corresponding to the pattern of parts of speech of the error region as being the correct word, and correct the error region of the text data to the correct word.

That is, the server 100 may store a plurality of sequentially arranged words in the storage 120 according to frequency of usage. For example, “starting time” may be a word having a high possibility of being used as a word consisting of two sequentially arranged words. Therefore, the detector 130 may detect a portion having a low possibility of being used as a word consisting of a plurality of sequentially arranged words as an error region. In addition, the corrector 140 may check the pattern of parts of speech of the detected error region, and correct the error region to the word having the highest possibility of pronunciation similarity and frequency of usage of among the candidate words corresponding to the checked pattern of parts of speech.

The detector 130 may calculate the possibility of a first word and a second word of among the plurality of words configuring the text data to be included in a same sentence, and in response to the possibility of the first word and the second word being included in a same sentence being less than a predetermined value, the detector 130 may detect at least one of the first word and the second word as being an error region.

In addition, the detector 130 may compare the standard pattern of parts of speech stored in the storage 120 with the pattern of parts of speech of the text data based on n-gram, and detect an error region of the recognized user voice. More specifically, 1-gram parts of speech refers to a speech consisting of one part of speech, 2-gram parts of speech refers to a speech consisting of two sequential parts of speech, and 3-gram parts of speech refers to a speech consisting of three sequential parts of speech. For example, “man is” is a 2-gram language consisting of a noun and a verb. Furthermore, “starting time” is a 2-gram language since two words are sequentially arranged regardless of the parts of speech.

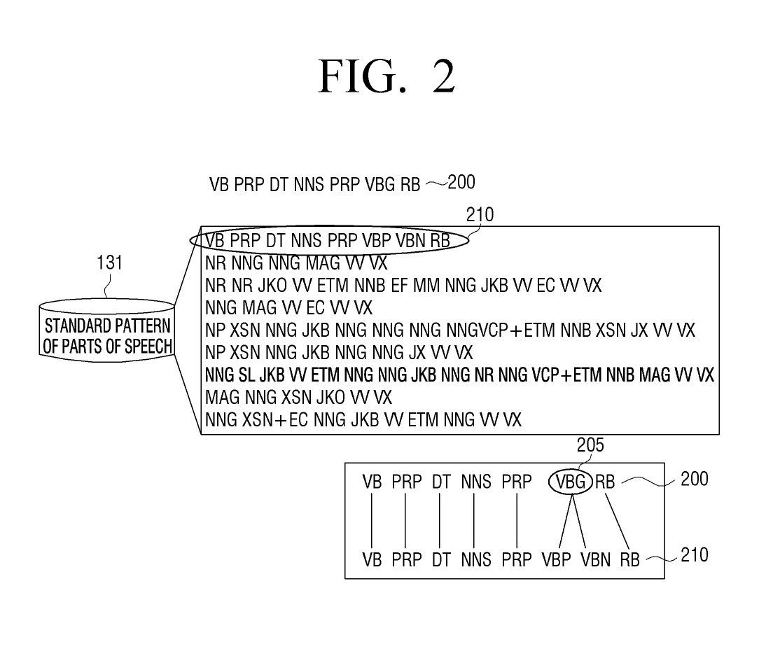

A method for detecting an error region and correcting the error region will be explained hereinafter with reference to FIG. 2.

The text data obtainer may obtain text data by recognizing a user voice by means of natural language processing of the user's utterance and or by receiving a voice recognition result from a voice recognition server or module.

The determine 110 may determine the part of speech of the text data and determine the pattern of parts of speech by tagging the part of speech to each word included in the text data in an analysis cover format. That is, the pattern of parts of speech of the text data 200 may be determined as illustrated in FIG. 2.

As mentioned above, a pattern of parts of speech refers to at least one part of speech obtained and connected by tagging the part of speech to each word included in the text data in a promised analysis cover format. The promised analysis cover refers to a promised symbol according to the part of speech such as NN for noun, NP for verb, and VV for verb.

For example, when the text data corresponding to a user voice is “show me the channels I've watched recently”, since this is a sentence consisting of a verb base form, a personal pronoun, a determiner, a noun, a personal pronoun, a non-3rd person singular present, a past participle and an adverb, the pattern of parts of speech becomes ‘VB, PRP, DT, NNS, PRP, VBP, VBN, RB.’

In response to the determiner 110 having determined the pattern of parts of speech of the obtained text data, the detector 130 may determine the pattern of parts of speech having the highest possibility of corresponding to the pattern of parts of speech 200 of the text data using the pattern of parts of speech 131 stored in the storage 120.

That is, the server 100 may analyze the parts of speech of all the language of the user that can be recognized using the voice recognition function by the determiner 110, and tag the part of speech analysis cover according to each part of speech and create a pattern of parts of speech. In addition, the storage 120 may store the various pattern of parts of speech determined by the determiner 110 as a standard pattern of parts of speech 131. Therefore, the detector 130 may determine, of among the standard pattern of parts of speech 131, the pattern of parts of speech having the highest possibility of corresponding to the pattern of parts of speech of the text data 200.

For example, the case where the text data of “show me the channels I've watched recently” is input, but the text data obtainer recognizes as “show me the channels I watching recently” is exampled. The determiner 110 may determine the pattern of parts of speech of the text data 200 as ‘VB, PRP, DT, NNS, PRP, VBG, RB.’

The detector 130 may determine the pattern of parts of speech having similar types and order of parts of speech included in the pattern of parts of speech of the text data 200. Therefore, as illustrated in FIG. 2, the detector 130 may detect the pattern of parts of speech “VB, PRP, DT, NNS, PRP, VBP, VBN, RB” as the similar pattern of parts of speech 210, and align it with the pattern of parts of speech of the text data 200, and compare the pattern of parts of speech.

Therefore, when aligning the pattern of parts of speech 210 similar to those of the pattern of parts of speech of the text data 200, the detector 130 may determine that the “VBG” region corresponding to “watching” of the text data is different from “VBP VBN” of the similar pattern of parts of speech 210. Therefore, the detector 130 may detect the different regions “VBG” 205 as error regions.

The corrector 140 may determine, as a correct part of speech, “VBP VBN” which is of a similar pattern of parts of speech 210 corresponding to the “VBG” error region 205 that the detector 130 detected as being an error region. That is, the error region “VBG” 205 consists of a gerund (-ing form), but when compared with a similar pattern of parts of speech stored in the standard pattern of parts of speech 131, the corrector 140 may determine that a word of the part of speech of a non-3rd person singular present and a past participle should be included.

In the abovementioned example of “show me the channels I watching recently,” when determining the correct part of speech, the corrector 140 may determine a word stored as a non-3rd person singular present and a past participle in the storage 120 as the correct word. That is, the corrector 140 may determine, of among the words classified as being a non-3rd person singular present and a past participle (that is the correct part of speech) and stored in the storage 120, a candidate word that is pronounced similarly as the word of “MM, NNB” region 205 and that has a high frequency of usage as the correct word. When a plurality of words are determined as a correct word by the corrector 140, the server 100 may output only the word having the highest accuracy or output the plurality of words in the order of accuracy or frequency of usage.

In the abovementioned example of “show me the channels I watching recently”, the corrector 140 may correct “watching” of “VBG” region 205 to “have watched”, that is the word corresponding to “VBP VBN” the correct part of speech.

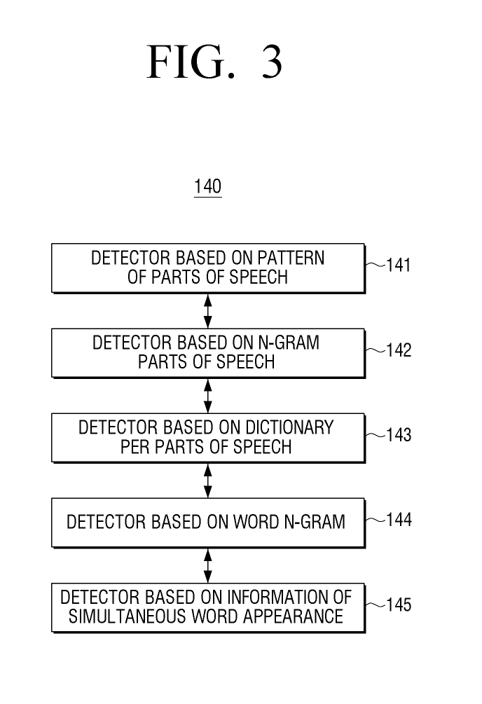

The detector 130 may include a configuration of detecting an error in various ways as illustrated in FIG. 3. That is, the detector 130 may include a detector based on pattern of parts of speech 141, detector based on n-gram of parts of speech, detector based on dictionary of parts of speech 143, detector based on word n-gram 144, and detector based on information of simultaneous word appearance 145. However, the detector 130 may not include all of the aforementioned configurative elements, and different configurative elements may be included according to the method of detecting an error region used in the server 100. In addition, even when the detector 130 includes all the aforementioned configurative elements, only some of the detector may be used to detect an error region depending on the text data obtained.

The detector based on pattern of parts of speech 141 is a configurative element for comparing and aligning the pattern of parts of speech of the text data with the pattern of parts of speech of the standard pattern of parts of speech 131 stored in the storage 120 to determine a different section, thereby detecting an error region.

The detector based on n-gram of parts of speech 142 is a configurative element for classifying the parts of speech included in the text data based on n-gram, and detecting the error region included in the pattern of parts of speech. More specifically, 1-gram parts of speech is a speech consisting of one part of speech, 2-gram parts of speech is a speech consisting of two sequential parts of speech, and 3-gram parts of speech is a speech consisting of three sequential parts of speech. For example, “man is” is a 2-gram language consisting of a noun and a verb.

Therefore, the detector based on n-gram parts of speech 142 may determine whether or not a n-gram parts of speech are parts of speech appropriate to be used in that sequential order, and detect a region containing any parts of speech that cannot be sequentially arranged as being an error region.

For example, in the case of detecting an error region of a 2-gram parts of speech pattern, parts of speech that cannot be sequentially arranged such as “adjective+verb” is not stored in the standard pattern of parts of speech of the storage 120, and thus if a portion of the text data includes “adjective+verb”, the detector based on n-gram parts of speech 142 may detect the area determined to have a pattern of “adjective+verb” as being an error region.

The detector 143 based on dictionary per part of speech 143 is configured to detect an error region using a dictionary where words are stored per parts of speech. For example, in the case of a bound noun which has a formal meaning and thus can only be used depending on another word, the analysis cover “NNB” is tagged. If the word of the region tagged with “NNB” does not correspond to a word classified and stored in the storage 120 as a bound noun, the detector based on dictionary per parts of speech 143 may detect the region tagged with “NNB” as an error region.

The detector based on word n-gram 144 is a configurative element for classifying the word included in the text data based on n-gram, and detecting an error region. More specifically, word 1-gram is a speech consisting of one word, word 2-gram is a speech consisting of two sequentially arranged words, and word 3-gram is a speech consisting three sequentially arranged words. For example, “starting time” is a 2-gram language since two words are sequentially arranged.

Therefore, detector based on word n-gram 144 may determine whether or not n-gram words are suitable to be used sequentially, and detect the region containing a word not suitable to be used sequentially as an error region.

For example, in the case of detecting an error region of a 2-gram speed, in the case of a word that has an awkward meaning when sequentially arranged such as “starting timb or a word that is not stored in the storage 120, or a word having an extremely low frequency of usage, the detector based on word n-gram 144 may detect the region including “starting timb” of the text data as an error region.

Herein, since “starting timb” is a 2-gram word consisting of two sequentially arranged nouns, the corrector 140 may detect a correct word from the list of 2-gram words consisting of two sequential nouns and make a correction.

That is, in consideration of the similarity of pronunciation with “starting timb” and the frequency of using from the list of 2-gram words consisting of two sequentially arranged nouns, the corrector 140 may determine “starting time” as the correct word and make a correction.

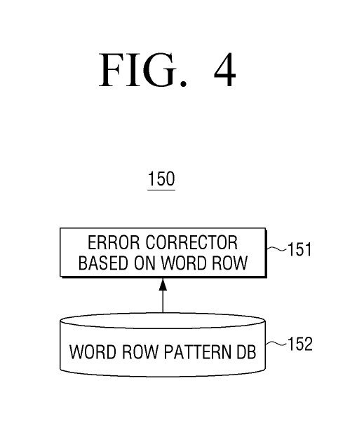

That is, as illustrated in FIG. 4, the error corrector based on word row matching 151 in the corrector 150 may determine the correct word using a word row pattern database (DB) 152 stored in the storage 120.

The word row DB 152 is a database for storing the words aligned according to parts of speech of each language or frequency of usage by a plurality of users. In addition, in the case of storing words according to parts of speech, the word row pattern DB 152 may store data based on n-gram.

For example, in the case of 2-gram parts of speech, the word row pattern DB 152 may store words of two sequential parts of speech such as the list of words of an adjective and noun or noun and noun according to the type of 2-gram parts of speech.

The detector based on information of simultaneous word appearance 145 may determine whether or not the word combination of a portion of words of among a plurality of words configuring the text data is less than a predetermined value, and detect an error region.

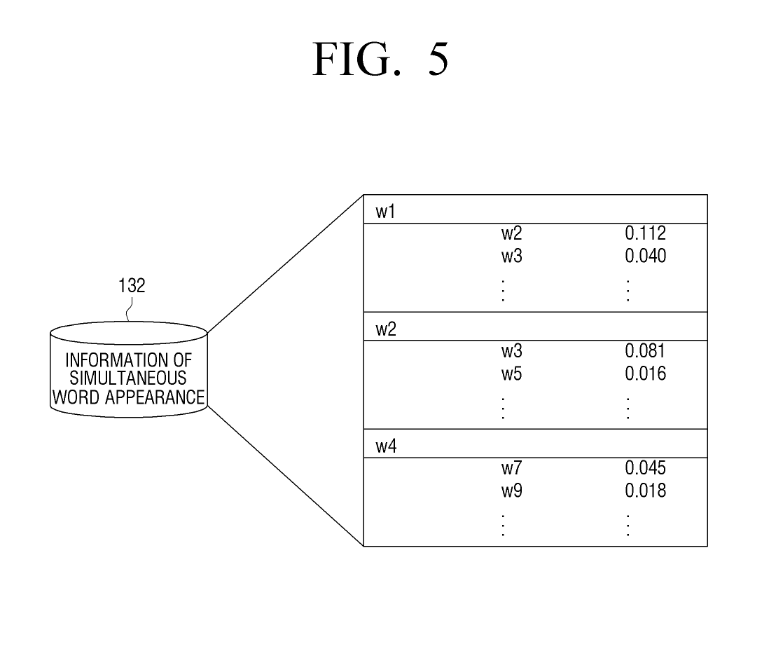

That is, as illustrated in FIG. 5, the storage 120 may store word simultaneous appearance information 132 which is the data of possibilities that a plurality of word combinations may be used in one sentence. The word simultaneous appearance information 132 may include data of possibilities of words being used in one sentence at the same time. More specifically, the word simultaneous appearance information 132 may include information showing that the possibility of w1 and w2 being used in one sentence is 0.112, the possibility of w1 and w3 being used in one sentence is 0.040, the possibility of w2 and w3 being used in one sentence is 0.081, and the possibility of w2 and w5 being used in one sentence is 0.016.

Therefore, in the case where the text data obtained via the text data obtainer is a sentence consisting of “w1, w2, w3, and w5”, the detector based on information of simultaneous word appearance 145 may determine that the text data simultaneously including w2 and w5 of which the possibility of being used in one sentence is only 0.016 based on the word simultaneous appearance information 132, and detect w2 or w5 as an error region.

Herein, the corrector 140 may determine a candidate word having the highest pronunciation similarity and frequency of usage of among the words stored as parts of words corresponding to w2 and w5 as the correct word, and make a correction to w2 or w5.

The corrector 140 may determine the correct word for the error region and correct the error region, but the corrector 140 may also expand the error region to the front or back word of the error region detected by the detector 130 and determine the correct word accordingly. That is, there is a high possibility that the front or back word of the region determined as being the error region is recognized incorrectly, and thus in order to make a precise correction of the word, the corrector 140 may expand the error region to the front or back word of the error region detected by the detector 130 and determine the correct word accordingly.

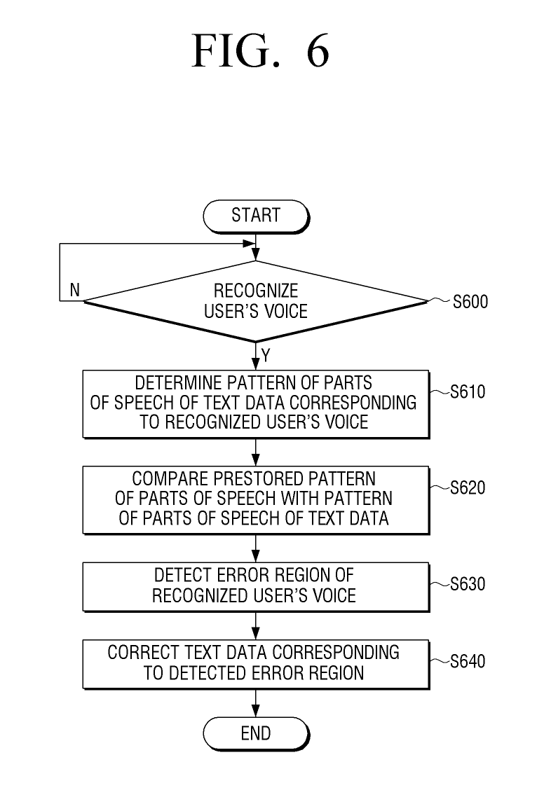

FIG. 6 is a flowchart illustrating a method for correcting an error of a voice recognition result.

First of all, in response to a user voice being recognized (S600-Y), the server 100 determines the pattern of parts of speech of the text data corresponding to the recognized user voice (S610).

That is, the server 100 may receive the user voice uttered, analyze the received user voice nu natural language processing and the like, and obtain the text of the text data corresponding to the analyzed user voice. Otherwise, the server 100 may receive text data corresponding to the user voice recognized in a separate voice recognition server and obtain text data.

Furthermore, the server compares the prestored pattern of parts of speech with the pattern of parts of speech of the text data (S620). That is, the server 100 stores a standard pattern of parts of speech. That is, the server 100 may analyze parts of speech of all the language of the user and tag the part of speech analysis cover according to each part of speech and create a pattern of parts of speech. In addition, the server 100 may store various pattern of parts of speech as a standard pattern of parts of speech.

For example, the server 100 may compare the order of arrangement of the parts of speech of the text data with those of the stored plurality of standard patterns of parts of speech, and determine the pattern of parts of speech having the highest possibility of correspondence. In addition, the server 100 may align the determined standard pattern of parts of speech with the pattern of parts of speech of the text data, and compare the aligned standard pattern of parts of speech with the pattern of parts of speech of the text data.

In addition, the server 100 detects an error region of the recognized user voice (S630). That is, the server 100 may detect the different section as a result of comparing the pattern of parts of speech of the text data with the standard pattern of parts of speech as being an error region.

That server 100 corrects the text data corresponding to the detected error region (S640). That is, the server 100 may use the aligned standard pattern of parts of speech to determine a correct part of speech of the error region. More specifically, the server 100 may determine the region in the standard pattern of parts of speech that is different from the pattern of parts of speech of the text data as the correct part of speech of the text data. In addition, the server 100 may determine the corrector 140 may determine a candidate word having the highest similarity in pronunciation and frequency of usage of among candidate words corresponding to the correct parts of speech as being the correct word, and correct the error region of the text data corresponding to the correct word.

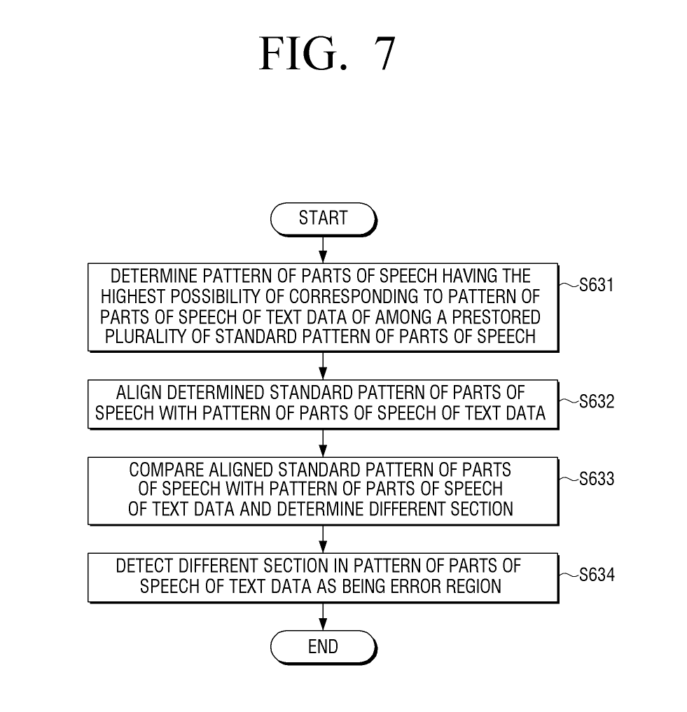

FIG. 7 is a flowchart of a method for detecting an error region.

That is, the server 100 determines the pattern of parts of speech having the highest possibility of corresponding to the pattern of parts of speech of the text data of among the plurality of prestored standard patterns of parts of speech (S631). For example, the server 100 may determine which pattern of parts of speech has the highest possibility of corresponding to the pattern of parts of speech of the text data by comparing the order in which the parts of speech of the text data are arranged with those in the plurality of patterns of parts of speech.

Furthermore, the server 100 may align the determined standard pattern of parts of speech with the pattern of parts of speech of the text data (S632), and compare the aligned standard pattern of parts of speech with the pattern of parts of speech of the text data and determine a different section (S633).

In addition, the server 100 detects the different section in the pattern of parts of speech of the text data as an error region (S634).

As such, according to various exemplary embodiments, there is provided a server that is capable of efficiently correcting a result of voice recognition regardless of the type of the voice recognition server or module, manufacturer or developer, thereby improving the voice recognition performance.

An error correcting method of a result of voice recognition according to the aforementioned various exemplary embodiments may be encoded as software that is stored in a non-transitory readable medium and executed by a hardware processor or circuit. Such a non-transitory readable medium may be mounted on various devices and be used.

A non-transitory readable medium refers to a computer readable medium that stores data semi-permanently rather than storing data for a short period of time such as a register, cache, and memory etc. More specifically, it may be a CD, DVD, hard disc, blue-ray disc, USB, memory card, and ROM and the like.

Although a few exemplary embodiments have been shown and described, it would be appreciated by those skilled in the art that changes may be made without departing from the principles and spirit of the inventive concept, the scope of which is defined in the claims and their equivalents.

What is claimed is:

1. A method of correcting an error of a voice recognition, the method comprising:
in response to recognizing a user voice, determining a pattern of parts of speech of text data corresponding to the recognized user voice;
comparing a prestored standard pattern of parts of speech with the pattern of parts of speech of text data;
detecting an error region of the recognized user voice based on a result of the comparing; and
correcting the text data corresponding to the detected error region.

2. The method according to claim 1, wherein the detecting comprises:
determining a standard pattern of parts of speech having a highest possibility of corresponding to the pattern of parts of speech of the text data of among a plurality of prestored standard patterns of parts of speech;
aligning the determined standard pattern of parts of speech with the pattern of parts of speech of the text data;
comparing the aligned standard pattern of parts of speech with the pattern of parts of speech of the text data;
determining a different section based on a result of the comparing; and
detecting the different section among the pattern of parts of speech of the text data as being the error region.

3. The method according to claim 2, wherein the correcting comprises:
determining a correct part of speech of the error region using the aligned standard pattern of parts of speech;
determining a candidate word having a highest pronunciation similarity and frequency of usage of among candidate words corresponding to the correct pattern of part of speech; and
correcting the error region of the text data to the correct word.

4. The method according to claim 1, wherein the detecting comprises, in response to a portion of the pattern of parts of speech of a plurality of words configuring the text data not corresponding to the prestored standard pattern of parts of speech, detecting a section corresponding to the portion of the plurality of the words as being an error section.

5. The method according to claim 4, wherein the correcting comprises:
determining a correct pattern of parts of speech corresponding to the portion of the pattern of parts of speech of among the plurality of words; and
determining a candidate word having a highest pronunciation similarity and frequency of usage of among candidate words corresponding to the correct pattern of part of speech and correcting the error region of the text data to the correct word.

6. The method according to claim 1, wherein the detecting comprises, in response to a possibility of usage of a word combination of among a plurality of words configuring the text data being less than a predetermined value, detecting the word combination as being the error region.

7. The method according to claim 6, wherein the correcting comprises:
determining a pattern of parts of speech of the error region; and
determining a candidate word having a highest pronunciation similarity and frequency of usage of among candidate words corresponding to the pattern of parts of speech of the error region and correcting the error region of the text data to the correct word.

8. The method according to claim 1, wherein the detecting comprises:
determining a possibility of a first word and second word of among a plurality of words configuring the text data being included in a same sentence; and
in response to the possibility of the first word and second word being included in the same sentence being less than a predetermined value, detecting at least one of the first word and second word as being the error region.

9. The method according to claim 1, wherein the detecting comprises comparing the prestored standard pattern of parts of speech with the pattern of parts of speech of the text data based on n-gram, and detecting the error region of the recognized user voice based on the comparing a result of the comparing.

10. A server comprising:
a determiner configured to, in response to a user voice being recognized, determine a pattern of parts of speech of obtained text data corresponding to the recognized user voice;
a storage configured to store a standard pattern of parts of speech;
a detector configured to compare the standard pattern of parts of speech stored in the storage with the pattern of parts of speech of the text data determined by the determiner and detect an error region of the recognized user voice based on a result of the comparison; and
a corrector configured to correct text data corresponding to the error region detected by the detector.

11. The server according to claim 10, wherein the detector is configured to determine a standard pattern of parts of speech having a highest possibility of corresponding to the pattern of parts of speech of the text data of among a plurality of standard patterns of parts of speech stored in the storage and align the determined standard pattern of parts of speech with the pattern of parts of speech of the text data, and compare the aligned standard pattern of parts of speech and the pattern of parts of speech of the text data to determine a different section, and detect the different section of among the pattern of parts of speech of the text data as being the error region.

12. The server according to claim 11, wherein the corrector is configured to determine a correct part of speech of the error region using the aligned standard pattern of parts of speech, determine a candidate word having a highest pronunciation similarity and frequency of usage of among candidate words corresponding to the correct pattern of part of speech and correct the error region of the text data to the correct word.

13. The server according to claim 10, wherein the detector is configured to, in response to a portion of the pattern of parts of speech of a plurality of words configuring the text data not corresponding to the prestored standard pattern of parts of speech, detect a section corresponding to the portion of the plurality of the words as being an error section.

14. The server according to claim 13, wherein the corrector is configured to determine a correct pattern of parts of speech corresponding to the portion of the pattern of parts of speech among the plurality of words, determine a candidate word having a highest pronunciation similarity and frequency of usage of among candidate words corresponding to the correct pattern of part of speech and correct the error region of the text data to the correct word.

15. The server according to claim 10, wherein the detector is configured to, in response to the possibility of usage of a word combination of among a plurality of words configuring the text data being less than a predetermined value, detect the word combination as being the error region.

16. The server according to claim 15, wherein the corrector is configured to determine a pattern of parts of speech of the error region, determinea candidate word having a highest pronunciation similarity and frequency of usage of among candidate words corresponding to the pattern of part of speech of the error region and correct the error region of the text data to the correct word.

17. The server according to claim 10, wherein the detector is configured to determine a possibility of a first word and second word of among a plurality of words configuring the text data being included in a same sentence; and in response to the possibility of the first word and second word being included in a same sentence being less than a predetermined value, detect at least one of the first word and second word as being the error region.

18. The server according to claim 10, wherein the detector is configured to compare the prestored standard pattern of parts of speech with the pattern of parts of speech of the text data based on n-gram, and detect an error region of the recognized user voice.
